(19) United States
(12) Patent Application Publication
(10) Pub. No.: US 2012/0112973 A1
(43) Pub. Date: May 10, 2012

(54) ANTENNA OF RESONANCE FREQUENCY VARIABLE TYPE

(76) Inventors: Byung Hoon Ryou, Seoul (KR); Won Mo Sung, Gyeonggi-do (KR); Jeong Pyo Kim, Seoul (KR)

(21) Appl. No.: 12/673,163

(22) PCT Filed: Aug. 13, 2008
(86) PCT No.: PCT/KR08/04685

§ 371 Date: Jul. 9, 2010

(30) Foreign Application Priority Data
Aug. 13, 2007 (KR) 10-2007-0081227

(51) Int. Cl. H01Q 5/01

(52) U.S. Cl. 343/745

(57) ABSTRACT

The present invention relates to a resonance frequency variable type antenna which has as low operating frequency as mobile broadcasting service bands of T-DMB and DVB-H and a wide frequency bandwidth and can select and receive various channels using a loop antenna capable of varying a resonance frequency through a variable capacitor. Particularly, the resonance frequency variable antenna can be mounted in a limited space, use two different service bands (T-DMB and DVB-H) and independently operate for the two service bands to achieve high-quality mobile broadcasting services. Accordingly, various mobile broadcasting services can be provided using a single antenna and the product values and reliabilities of the resonance frequency variable type antenna of the invention and mobile terminals including the resonance frequency variable antenna of the invention can be improved.

### TECHNICAL FIELD

The present invention relates to a resonance frequency variable type antenna, and more particularly, to an antenna having as low operating frequency as mobile broadcasting service bands (for example, T-DMB and DVB-H) and a wide frequency bandwidth, which uses a small-sized frequency variable loop antenna capable of varying a resonance frequency through a variable capacitor, is mounted in a narrow space and independently operates for different two service bands (T-DMB and DVB-H) to provide high-quality mobile broadcasting service.

Particularly, the present invention presents a resonance frequency variable type antenna capable of providing various mobile broadcasting services to improve the product value and reliability of mobile terminals including the antenna.

### BACKGROUND ART

With development of electronic industry and communication technology, particularly, wireless communication technology, a variety of mobile terminals capable of performing voice and data communications with any one anytime any place have been developed and popularized.

One of important techniques in the wireless communication technology is a technique relating to antennas, and various antennas including coaxial antennas, rod antennas, loop antennas, beam antennas and super gain antennas are known.

To improve portability of mobile terminals, a variety of techniques for reducing the size of the mobile terminals (for example, high-density integrated circuits and techniques for miniaturizing electronic circuit boards) have been developed. Furthermore, built-in antennas and chip type built-in antennas using printed circuit boards (PCBs) have been developed in order to decrease the size of an antenna included in a mobile terminal to reduce the size of the mobile terminal.

As people are increasingly interested in mobile broadcasting services, terrestrial digital multimedia broadcasting (T-DMB) service using a very high frequency (VHF) of 30 to 300 MHz and digital video broadcasting-handheld (DVB-H) service using an ultra high frequency (UHF) of 300 to 3000 MHz are prepared, and thus antennas for handheld terminals for using these services are required.

### DISCLOSURE OF INVENTION

### Technical Problem

A built-in antenna for mobile broadcasting services is required to be mounted in a small space inside a mobile terminal and have a wide frequency bandwidth although the built-in antenna has a large size due to its low frequency band. Accordingly, it is difficult to realize the built-in antenna for the mobile broadcasting services.

In other words, it is required to develop a built-in antenna that can be mounted in a narrow space while satisfying a relatively low frequency band and a wide bandwidth.

The present invention has been made to solve the above-mentioned problems occurring in the conventional art, and a primary object of the present invention is to provide a resonance frequency variable antenna which has as wide frequency bandwidth as mobile broadcasting service bands of T-DMB and DVB-H and can select and receive various channels using a loop antenna capable of varying a resonance frequency through a variable capacitor.

Another object of the present invention is to provide a resonance frequency variable antenna which is mounted in a limited space, uses two different service bands (T-DMB and DVB-H) and independently operates for the two service bands to achieve high-quality mobile broadcasting services.

### Technical Solution

According to an aspect of the present invention, there is provided a resonance frequency variable type antenna including a radiating element having a first terminal connected to a power supply; a radiating element having a first terminal connected to the ground; a first resonance unit connecting a second terminal of the radiating element connected to the power supply and a second terminal of the radiating element connected to the ground and generating resonance corresponding to a first resonance frequency; a second resonance unit connecting the second terminal of the radiating element connected to the power supply and the second terminal of the radiating element connected to the ground and generating resonance corresponding to a second resonance frequency; and a variable capacitor connected to one side of each of the first and second resonance units to adjust the resonance frequencies.

A first band selecting switch selectively connecting the first and second resonance units to the radiating element connected to the power supply may be connected to the second terminal of the radiating element connected to the power supply unit, and a second band selecting switch corresponding to the first band selecting switch and selectively connecting the first and second resonance units to the radiating element connected to the ground may be connected to the second terminal of the radiating element connected to the ground.

The radiating element connected to the power supply may include a first radiating element connected to the first resonance unit and a second radiating element connected to the second resonance unit, and the radiating element connected to the ground may include a first radiating element connected to the first resonance unit and a second radiating element connected to the second resonance unit.

The first and second radiating elements connected to the power supply may be perpendicular to each other and the first and second radiating elements connected to the ground may be perpendicular to each other.

Each of the first and second resonance units may include two inductors and a transmission line connecting the two inductors.

According to another aspect of the present invention there is provided an apparatus including the resonance frequency variable type antenna.

### ADVANTAGEOUS EFFECTS

As described above, the present invention can provide an antenna which is mounted in a narrow space and has as low operating frequency as mobile broadcasting service bands (for example, T-DMB and DVB-H) and a wide frequency bandwidth using a small-sized frequency variable loop antenna.

Furthermore, the present invention can present an antenna capable of changing a resonance frequency using a variable capacitor to provide mobile broadcasting services using various channels.

Particularly, the present invention presents an antenna independently operating for two different service bands (T-DMB and DVB-H) to provide high-quality mobile broadcasting services.

Moreover, the present invention can provide various mobile broadcasting services using a single antenna to enhance the product values and reliabilities of the resonance frequency variable antenna according to the present invention and mobile terminals including the resonance frequency variable antenna according to the present invention.

### BRIEF DESCRIPTION OF THE DRAWINGS

Further objects and advantages of the invention can be more fully understood from the following detailed description taken in conjunction with the accompanying drawings, in which:

FIG. 1 illustrates a configuration of a resonance frequency variable antenna according to an embodiment of the present invention;

FIG. 2 illustrates a configuration of a resonance frequency variable antenna according to another embodiment of the present invention;

FIGS. 3 and 4 are graphs showing characteristics of the resonance frequency variable antenna illustrated in FIG. 2;

FIG. 5 illustrates a configuration of a resonance frequency variable antenna according to another embodiment of the present invention;

FIGS. 6 and 7 are graphs showing characteristics of the resonance frequency variable antenna illustrated in FIG. 5;

FIG. 8 illustrates a configuration of a resonance frequency variable antenna according to another embodiment of the present invention; and

FIGS. 9 and 10 are graphs showing characteristics of the resonance frequency variable antenna illustrated in FIG. 8.

### BEST MODE FOR CARRYING OUT THE INVENTION

Resonance frequency variable antennas according to preferred embodiments of the present invention will be explained with reference to the attached drawings.

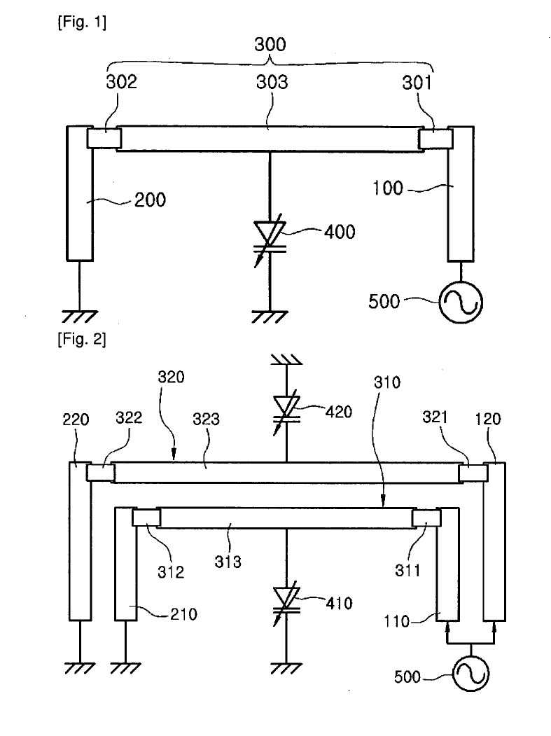

FIG. 1 illustrates a configuration of a resonance frequency variable antenna according to an embodiment of the present invention. Referring to FIG. 1, a loop antenna includes a radiating element 100 connected to a power supply 500, a radiating element 200 connected to the ground, and a resonance unit 300 determining a resonance frequency. A variable capacitor 400 is connected to one side of the resonance unit 300.

Here, the variable capacitor 400 is used to finely adjust the resonance frequency determined by the resonance unit 300.

The resonance unit 300 includes an inductor 301 on the power supply side, an inductor 302 on the ground side, and a transmission line 303 connected between the inductor 301 and the inductor 302.

The resonance frequency is determined by the resonance unit 300 and controlled by the variable capacitor 400.

To use two different service bands using the aforementioned resonance frequency variable antenna according to the present invention, the resonance frequency variable antenna can include a first resonance unit 310 for using one of the service bands and a second resonance unit 320 for using the other service band, as illustrated in FIG. 2.

The first resonance unit 310 includes a first inductor 311 on the power supply side and a first inductor 312 on the ground side, which determine a first resonance frequency for one of the service bands, and a first transmission line 313 connected between the first inductor 311 on the power supply side and the first inductor 312 on the ground side. The second resonance unit 320 includes a second inductor 321 on the power supply side and a second inductor 322 on the ground side, which determine a second resonance frequency for the other service band, and a second transmission line 323 connected between the second inductor 321 on the power supply side and the second inductor 322 on the ground side.

A first variable capacitor 410 for varying the first resonance frequency is connected to one side of the first transmission line 313 and a second variable capacitor 420 for varying the second resonance frequency is connected to one side of the second transmission line 323.

A first radiating element 110 on the power supply side and a first radiating element 210 on the ground side are respectively connected to both ends of the first resonance unit 310 and a second radiating element 120 on the power supply side and a second radiating element 220 on the ground side are respectively connected to both ends of the second resonance unit 320.

The first radiating element 110 on the power supply side and the second radiating element 120 on the power supply side receive power from the power supply 500. Power supplied from the power supply unit 500 can be provided to the first radiating element 110 on the power supply side and the second radiating element 120 on the power supply side selectively or simultaneously at the request of a user.

Accordingly, it is possible to use the two service bands according to the resonance frequencies determined by the resonance units provided with power from the power supply unit 500.

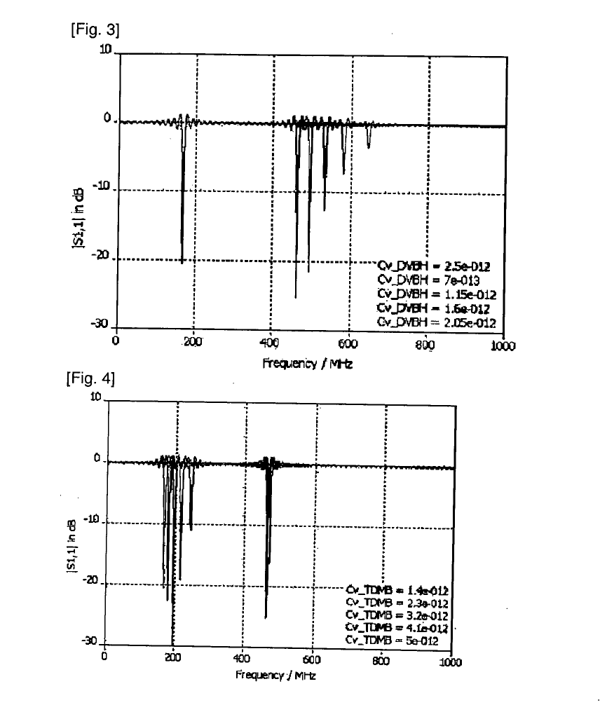

FIG. 3 is a characteristic graph showing a variation in the resonance frequency of the first resonance unit 310 according to a variation in the first variable capacitor 410 illustrated in FIG. 2 and FIG. 4 is a characteristic graph showing a variation in the resonance frequency of the second resonance unit 320 according to a variation in the second variable capacitor 420 illustrated in FIG. 2.

Referring to FIGS. 3 and 4, in the antenna supporting two bands of UHF and VHF, the resonance frequencies of the two bands can be independently controlled by adjusting the variable capacitors 410 and 420 without affecting the bands each other.

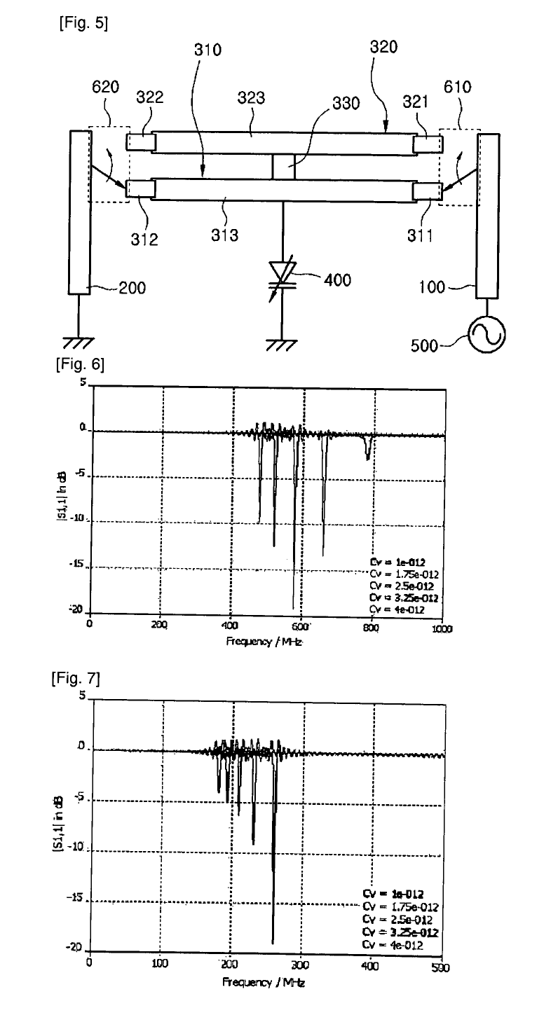

FIG. 5 illustrates a configuration of a resonance frequency variable antenna for using two different service bands according to another embodiment of the present invention.

Referring to FIG. 5, the resonance frequency variable antenna includes a first resonance unit 310 for using one of the two service bands and a second resonance unit 320 for using the other service band. The first resonance unit 310 and the second resonance unit 320 are electrically connected through a connecting transmission line 330.

The connecting transmission line 330 can be omitted and, in this case, the second resonance unit 320 can be connected to the variable capacitor 400.

The first resonance unit 310 includes a first inductor 311 on the power supply side and a first inductor 312 on the ground side, which determine a first resonance frequency for one of the service bands, and a first transmission line 313 connected between the first inductor 311 on the power supply side and the first inductor 312 on the ground side. The second resonance unit 320 includes a second inductor 321 on the power supply side and a second inductor 322 on the ground side, which determine a second resonance frequency for the other service band, and a second transmission line 323 connected between the second inductor 321 on the power supply side and the second inductor 322 on the ground side. The connecting transmission line 330 is connected between the first transmission line 313 and the second transmission line 323.

The variable capacitor 400 for varying the first resonance frequency or the second resonance frequency is connected to one side of the first transmission line 313.

In addition, a first band selecting switch 610 and a second band selecting switch 620 are respectively arranged on both sides of the first resonance unit 310 and the second resonance unit 320 and power supplied from the power supply unit 500 is provided to one of the first resonance unit 310 and the second resonance unit 320 according to operations of the first band selecting switch 610 and the second band selecting switch 620.

That is, when the first band selecting switch 610 and the second band selecting switch 620 are connected to the first resonance unit 310 as illustrated in FIG. 5, the power supplied from the power supply unit 500 is provided to the first resonance unit 310 and the variable capacitor 400 operates to vary the first resonance frequency.

If the first band selecting switch 610 and the second band selecting switch 620 are connected to the second resonance unit 320, the power supplied from the power supply unit 500 is provided to the second resonance unit 320 and the variable capacitor 400 operates to vary the second resonance frequency.

Accordingly, one of the two service bands can be used according to the resonance frequency generated by the resonance unit that receives power from the power supply unit 500.

FIG. 6 is a characteristic graph showing a variation in the resonance frequency of the first resonance unit 310 according to a variation in the variable capacitor 400 illustrated in FIG. 5 and FIG. 7 is a characteristic graph showing a variation in the resonance frequency of the second resonance unit 320 according to a variation in the variable capacitor 400 illustrated in FIG. 5.

Referring to FIGS. 6 and 7, in the antenna supporting two bands of UHF and VHF, the resonance frequencies of the two bands can be independently adjusted by controlling the variable capacitor 400 without affecting the bands each other.

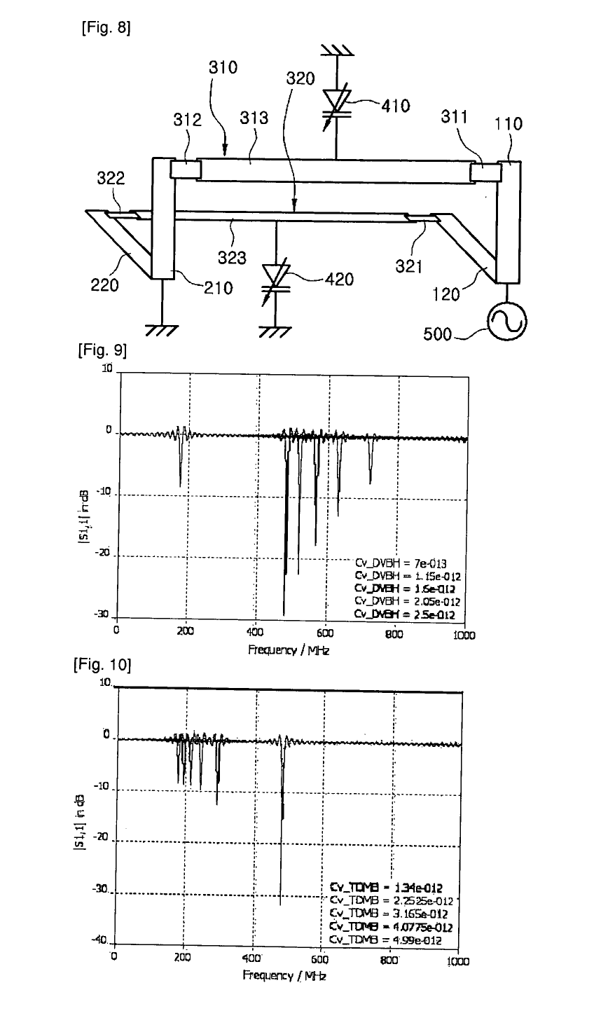

FIG. 8 illustrates a configuration of a resonance frequency variable antenna according to another embodiment of the present invention. Referring to FIG. 8, the resonance frequency variable antenna is constructed such that the first and second radiating elements 110 and 120 on the power supply side are perpendicular to each other and the first and second radiating elements 210 and 220 on the ground side are perpendicular to each other to minimize mutual influence of the first resonance unit 310 and the second resonance unit 320.

FIG. 9 is a characteristic graph showing a variation in the resonance frequency of the first resonance unit 310 according to a variation in the first variable capacitor 410 illustrated in FIG. 8 and FIG. 10 is a characteristic graph showing a variation in the resonance frequency of the second resonance unit 320 according to a variation in the second variable capacitor 420 illustrated in FIG. 8.

Referring to FIGS. 9 and 10, in the antenna supporting two bands of UHF and VHF, the resonance frequencies of the two bands can be independently adjusted by controlling the variable capacitors 410 and 420 without affecting the bands each other.

Accordingly, two different service bands can be used according to the resonance frequencies generated by the resonance units provided with power from the power supply unit 500 and an influence caused by radiation between the service bands can be minimized.

The resonance frequency variable antenna according to the present invention has been described. It will be understood by those of ordinary skill in the art that the technical configuration of the present invention can be changed in form and details without varying the spirit or characteristics of the invention. In particular, the resonance frequency variable antenna can include at least two resonance units and operate for at least three bands.

Furthermore, various mobile terminals and transceivers for wireless communication using the resonance frequency variable antenna according to the present invention can be included in the scope of the present invention.

Therefore, it will be understood by those skilled in the art that various changes in form and details may be made therein without departing from the spirit and scope of the invention as defined by the appended claims. The preferred embodiments should be considered in descriptive sense only and not for purpose of limitation. Therefore, the scope of the invention is defined not by the detailed description of the invention but by the appended claims, and all differences within the scope will be construed as being included in the present invention.

1. A resonance frequency variable type antenna comprising:
a radiating element having a first terminal connected to a power supply;
a radiating element having a first terminal connected to the ground;
a first resonance unit connecting a second terminal of the radiating element connected to the power supply and a second terminal of the radiating element connected to the ground and generating resonance corresponding to a first resonance frequency;
a second resonance unit connecting the second terminal of the radiating element connected to the power supply and the second terminal of the radiating element connected to the ground and generating resonance corresponding to a second resonance frequency; and
a variable capacitor connected to one side of each of the first and second resonance units to adjust the resonance frequencies.

2. The resonance frequency variable type antenna according to claim 1, wherein a first band selecting switch selectively connecting the first and second resonance units to the radiating element connected to the power supply is connected to the second terminal of the radiating element connected to the power supply unit, and a second band selecting switch and a second band selecting switch corresponding to the first band selecting switch and selectively connecting the first and second resonance units to the radiating element connected to the ground is connected to the second terminal of the radiating element connected to the ground.

3. The resonance frequency variable type antenna according to claim 1, wherein the radiating element connected to the power supply includes a fast radiating element connected to the first resonance unit and a second radiating element connected to the second resonance unit, and the radiating element connected to the ground includes a first radiating element connected to the first resonance unit and a second radiating element connected to the second resonance unit.

4. The resonance frequency variable type antenna according to claim 3, wherein the first and second radiating elements connected to the power supply are perpendicular to each other and the first and second radiating elements connected to the ground are perpendicular to each other.

5. The resonance frequency variable type antenna according to claim 1, wherein each of the first and second resonance units includes two inductors and a transmission line connecting the two inductors.

6. An apparatus comprising:
a radiating element having a first terminal connected to a power supply;
a radiating element having a first terminal connected to the ground;
a first resonance unit connecting a second terminal of the radiating element connected to the power supply and a second terminal of the radiating element connected to the ground and generating resonance corresponding to a first resonance frequency;
a second resonance unit connecting the second terminal of the radiating element connected to the power supply and the second terminal of the radiating element connected to the ground and generating resonance corresponding to a second resonance frequency; and
a variable capacitor connected to one side of each of the first and second resonance units to adjust the resonance frequencies.
